(19) United States
(12) Patent Application Publication
(10) Pub. No.: US 2022/0076079 A1
(43) Pub. Date: Mar. 10, 2022

(54) DISTRIBUTED MACHINE LEARNING SCORING

(71) Applicant: INTERNATIONAL BUSINESS MACHINES CORPORATION, ARMONK, NY (US)

(72) Inventors: Lukasz G. Cmielowski, Krakow (PL); Rafal Bigaj, Krakow (PL); Maksymilian Erazmus, Zasow (PL); Wojciech Sobala, Krakow (PL)

(21) Appl. No.: 16/948,223

(22) Filed: Sep. 9, 2020

(51) Int. Cl. G06K 9/62; G06F 9/54

(52) U.S. Cl. CPC G06K 9/6264; G06F 9/547; G06F 9/541

(57) ABSTRACT

An embodiment of the invention may include a method, computer program product, and system for scoring AI models. An embodiment may include a first computing system that determines a result of an AI model based on input data. An embodiment may include a first computing system that sends, to a second computing system, the result of the AI model. An embodiment may include a first computing system that receives, from the second computing system, a scoring result of the AI model.

### BACKGROUND

The present invention relates to artificial intelligence (AI), and more specifically, to distributed AI systems.

Machine learning (ML) is the study of computer algorithms that improve automatically through experience. It is seen as a subset of artificial intelligence. Machine learning algorithms build a mathematical model based on sample data, known as “training data”, in order to make predictions or decisions without being explicitly programmed to do so. Machine learning algorithms are used in a wide variety of applications, such as email filtering and computer vision, where it is difficult or infeasible to develop conventional algorithms to perform the needed tasks.

### BRIEF SUMMARY

An embodiment of the invention may include a method for scoring AI models. The method may include a first computing system that determines a result of an AI model based on input data. The method may include a first computing system that sends, to a second computing system, the result of the AI model. The method may include a first computing system that receives, from the second computing system, a scoring result of the AI model.

Another embodiment of the invention provides a computer program product for operating a first computing system for scoring AI models. The computer program product may include instructions for a first computing system that determines a result of an AI model based on input data. The computer program product may include instructions for a first computing system that sends, to a second computing system, the result of the AI model. The computer program product may include instructions for a first computing system that receives, from the second computing system, a scoring result of the AI model.

Another embodiment of the invention provides a first computing system for scoring AI models. The system may include a first computing system that determines a result of an AI model based on input data. The system may include a first computing system that sends, to a second computing system, the result of the AI model. The system may include a first computing system that receives, from the second computing system, a scoring result of the AI model.

### BRIEF DESCRIPTION OF THE DRAWINGS

FIG. 1 illustrates a distributed AI scoring system, in accordance with an embodiment of the invention;

FIG. 2 is a flowchart illustrating the operations of the scoring metric of FIG. 1, in accordance with an embodiment of the invention;

FIG. 3 is a block diagram depicting the hardware components of the computing systems of FIG. 1, in accordance with an embodiment of the invention;

FIG. 4 depicts a cloud computing environment according to an embodiment of the present invention; and

FIG. 5 depicts abstraction model layers according to an embodiment of the present invention.

### DETAILED DESCRIPTION

Embodiments of the present invention will now be described in detail with reference to the accompanying Figures.

The ability to calculate AI metrics is an extremely important feature in most AI systems. As such systems develop, custom AI metrics can be added in conjunction with typical metrics included in an AI development system. Such custom metrics may contain proprietary information that a developer prefers to have dominion and control over. Additionally, addition of non-native code to cloud systems that handle much of the computing resources for an AI development may present security issues to the cloud. Further, resource consumption and the maintenance of the runtime for execution may be computationally and/or economically expensive for the developer of the AI system.

Thus, in such systems, it is desirable to be able to distribute the computing across multiple devices or systems, where each of the systems may be owned and operated by separate entities. In such a system, the distribution may include a custom AI scoring algorithm located on a first computing system, while the AI model and generalized AI scoring algorithms may be located on a second computing system. Such a system may enable custom model evaluation parameters to be applied when performing model building or when performing any model bias testing to enable distributed ownership and security of proprietary information, as well ensuring security of cloud systems operating AI models.

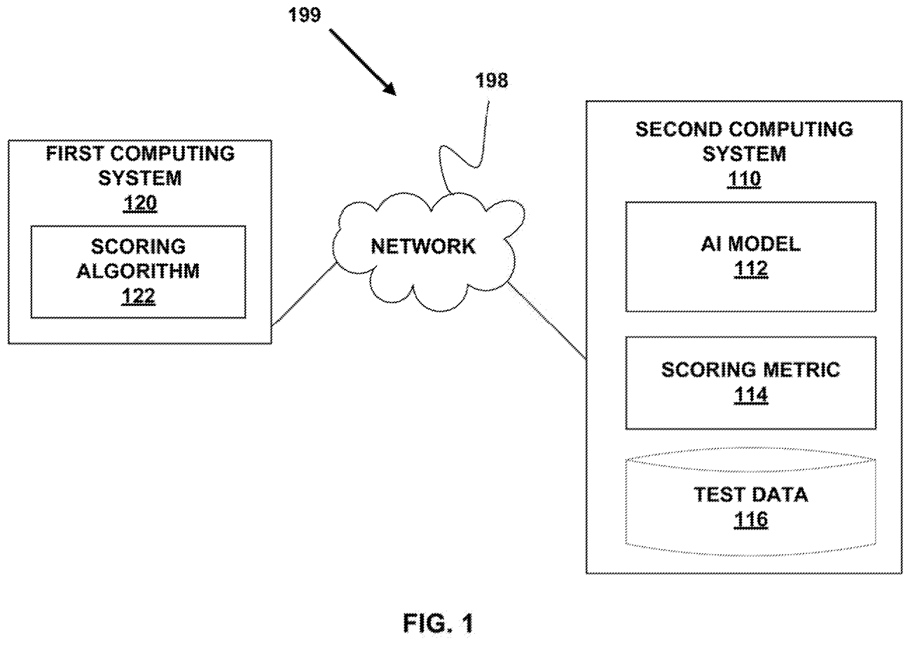

FIG. 1 illustrates distributed AI scoring system 199, in accordance with an embodiment of the invention. In an example embodiment, distributed AI scoring system 199 includes a first computing system 110 and a second computing system 120 interconnected via a network 198.

In the example embodiment, network 198 is the Internet, representing a worldwide collection of networks and gateways to support communications between devices connected to the Internet. Network 198 may include, for example, wired, wireless or fiber optic connections. In other embodiments, network 198 may be implemented as an intranet, a local area network (LAN), or a wide area network (WAN). In general, network 198 can be any combination of connections and protocols that will support communications between the first computing system 110 and the second computing system 120.

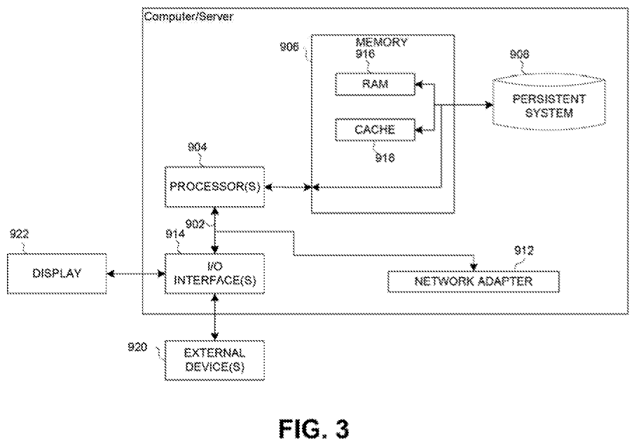

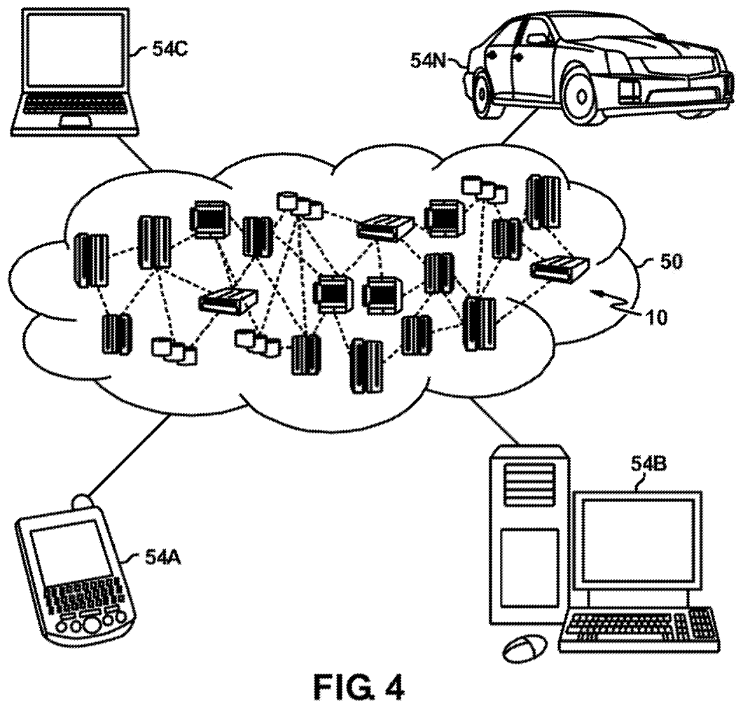

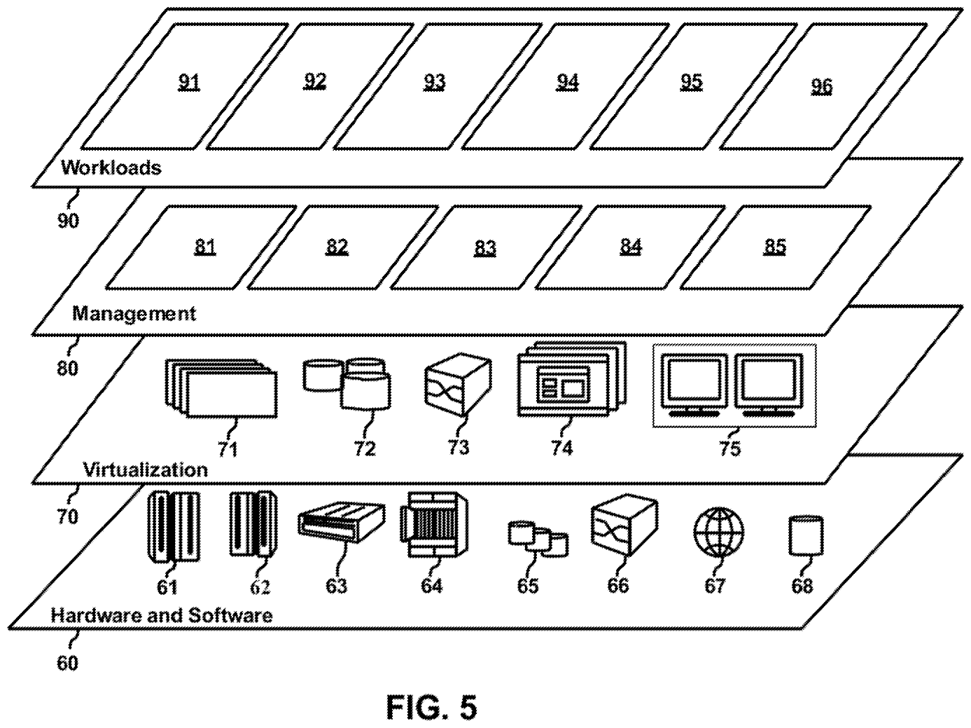

Second computing system 120 may include a scoring algorithm 122. Second computing system 120 may be a desktop computer, a notebook, a laptop computer, a tablet computer, a handheld device, a smart-phone, a thin client, or any other electronic device or computing system capable of receiving and sending data to and from other computing devices such as first computing system 110 via network 198. In an example embodiment, second computing system 120 may be used to accommodate the processing data from an AI model 112 and test data 116 in order to provide scoring results from scoring algorithm 122. Devices that make up second computing system 120 are described in more detail with reference to FIG. 3. Additionally, second computing system 120 may include a cluster of devices executing the same software to collectively handle the processing by scoring algorithm 122. Cloud embodiments of second computing system 120 are described in more detail with reference to FIGS. 4 and 5.

Scoring algorithm 122 may include one or more functions and/or formulas that may be used to evaluate the results of AI model 112 with regards to elements of test data 116. Scoring algorithm 122 may receive the relevant test data 116 to be scored, which may include input data to the AI model 112 as well as a result of the AI model 112. In some embodiments, scoring algorithm 122 may additionally receive ground truth data to compare to the results of the AI model 112 to create a score. In some embodiments, scoring algorithm 122 may score the AI model based on diverging decisions from similar input data. Additionally, scoring algorithm 122 may be a combination of the previous embodiments, or include additional mechanisms or metrics not.

First computing system 110 includes AI model 112, scoring metric 114 and test data 116. First computing system 110 may be used to accommodate the processing data from an AI model 112 and test data 116 in order to provide scoring results from scoring algorithm 122. In an example embodiment, first computing system 110 is a computing device, or collection of computing devices, that may store test data 116 and operate AI model 112 and scoring metric 114 on first computing system 110. First computing system 110 is described in more detail with reference to FIGS. 4 and 5.

AI model 112 may be an Artificial Intelligence (AI) or Machine Learning (ML) model trained on a collection of global data to solve a particular problem. AI model 112 may use AI algorithms such as, for example, Linear Regression, logistical Regression, Random Forest, Gradient Boosted Trees, Support Vector Machines (SVM), Neural Networks (including Convolutional Neural Networks and Deep Learning networks), Decision Trees, Naive Bayes, and Nearest Neighbor. In addition to the model selected, preprocessing techniques such as k-means clustering, mixture models, hierarchical clustering, hidden Markov models, blind signal separation, self-organizing maps (SOMs), adaptive resonance theory (ART), and any other applicable methods, may be used in conjunction with the AI algorithm to improve outputs based on the source data. Additionally, transformers or feature engineering elements may be included in the AI model 112. The AI model 112 may include one or more of each of the above types of elements in the final model.

Test data 116 may include data for testing and scoring AI model 112. Test data 116 may include ground truth data, or other real-world decision data, that may be used for modeling and testing. Test data 116 may additionally include parameter test data which may be created by scoring metric 114 in order to test whether differences in outcomes exist in AI model 112 for small variations in model inputs. In some embodiments, some or all of test data 116 may additionally be located (e.g., copied to or come from) on second computing system 120, which may reduce the need to send additional data to AI algorithm 112 during the use of the algorithm.

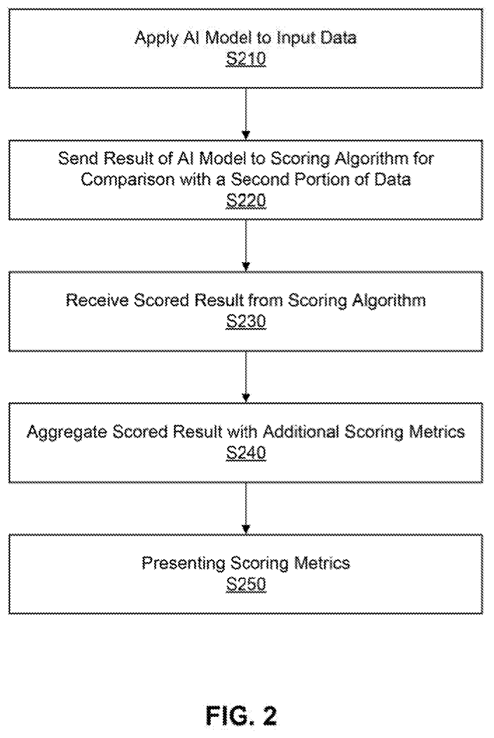

Scoring metric 114 may include one or more functions and/or formulas that may be used to evaluate the results of AI model 112 with regards to elements of test data 116. Scoring metric 114 may receive the relevant test data 116 to be scored, which may include input data to the AI model 112 as well as a result of the AI model 112. In some embodiments, scoring metric 114 may additionally receive ground truth data to compare to the results of the AI model 112 to create a score. In some embodiments, scoring metric 114 may score the AI model 112 based on diverging decisions from similar input data. Scoring metric 114 may additionally include functionality, as described in FIG. 2 and the text below, to send relevant results form AI model 112, as well as relevant input data from test data 116, to AI algorithm 112 and receive scores back from AI algorithm. Scoring metric 114 may additionally include functionality to create parameter test data, which may include creating data entries with minor changes between entries, to investigate the sensitivity of AI model 112 to changes in data to the outcome of the AI model 112, which may be used as a parameter for scoring the AI model 112 using scoring metric 114 and/or scoring algorithm 122. Scoring metric 114 may additionally include the ability determine which portions of test data 116 to send to the AI model 112 in order to test and score different metrics or parameters of the AI model 112.

FIG. 2 is a flow chart illustrating a method of including the scoring algorithm 122, via the scoring metric 114, in analysis of the AI model 112. Referring to step S210, input data selected from test data 116, or artificially created by scoring metric 114, may be input to the AI model 112. The AI model 112 may make decisions or predictions based on the data, and such decisions or predictions may be received via the scoring metric 114. In some embodiments, portions of test data 116 may be manipulated by the scoring metric 114 to test parameters of the AI model 112, or new data entries may be created to test parameters of the AI model 112. Scoring metric 114 may receive the determinations created by the AI model 112 for the input data and may begin to score the results of the model based on algorithms contained in scoring metric 114.

Referring to step S220, the scoring metric 114 sends relevant data and results used in the evaluation of AI model 112 to AI algorithm 112 to evaluate using the custom metric(s) located in AI algorithm 112. In some embodiments, the sending of data may be performed using a function call that is part of editable code located with the scoring metric 114. The function call my have a syntax of “scoring endpoint”:{“url”: “ ”, “authorization”: { }, “extra headers”: { }}, where url specifies the network location where the algorithm resides (e.g., an web address to a location outside of the control of the first computing system 110), authorization provides any security credentials that may needed to access the algorithm at the selected url, and extra_headers. Additionally, the function call may include the full data set (i.e., test data 116) to be scored or which elements identifiers and columns of the data set that were evaluated so AI algorithm 112 may retrieve the values from a local repository. Further, the function call may include data inputs created or manipulated by scoring metric 114. In alternative embodiments, while the function call may have similar elements, instead of allowing a user to input the variables through editable code, a GUI element may provide a user the necessary functionality to input relevant variables.

Still referring to step S220, the sending or relevant data from the second computing system 120 to the first computing system 110 may enable two systems with separate owners to communicate with each other in order to score an AI model. Further, the second computing system 120 and the first computing system 110 may be running different operating systems, or have different protocols, that may make cointegration infeasible. Additionally, by enabling such systems to operate at an arm's length it ensures security of the first computing system 110, while also providing confidentiality of the scoring algorithm 122. Because of the distributed ownership of second computing system 120 and first computing system 110, the computing systems may be located at separate physical locations, use different hardware as a backbone for such computing system, or include any other general variations in computing from separate ownership that may exist.

Referring to step S230, scoring metric may receive scores back from AI algorithm 112. Scores may be a numerical valuation and may be normalized in any manner as required by scoring metric 114.

Referring to step S240, scoring metric 114 may combine results from AI algorithm 112 with results of algorithms internal to scoring metric 114. The combination may be performed based on weighting of the metrics by the user. Additionally, scoring metric 114 may evaluate data trends from each of the models that led to poor scores, or were outliers, to be evaluated by the user.

Referring to step S250, the scoring metrics may be presented to a user. The scores may be individually displayed to the user or aggregated as a single score. Additionally, any outliers or variations of data input to the AI model 112 that were determined to negatively impact the scoring of an algorithm from scoring metric 114 or in AI algorithm 112 may be presented to the user for evaluation.

In an example use case of the above system, scoring metric 114 may be a part of IBM Watson® Open Scale™ (IBM, Watson, and Open Scale are trademarks of International Business Machines Corporation). IBM Watson® Open Scale™ is a product which uses a combination of scoring, and manipulating certain data variables, to determine whether a trained or in use AI model 112 is, for example, exhibiting unwanted biases. Such biases may be a result of either poor training data, or model drift during operation. In one example, IBM Watson® Open Scale™ may be used to determine discriminatory bias, or other types of illegal biases that may creep into a model based on incomplete or inadequate input data. In such a system, the user may want to use additional scoring metrics beyond those in the IBM Watson® Open Scale™ suite that might incorporate local regulations on such biases, or incorporate other company policies or experience in order to reduce such biases in the AI model 112. In such an instance, the system and methods explained above enable the user to take advantage of the suite of products included on IBM Watson® Open Scale™ while also maintaining control over the AI algorithm 112. Additionally, this eliminates security concerns that may be involved with introducing non-native code into the IBM Watson® Open Scale™ platform.

In an example use case of the above system, scoring metric 114 may be a part of IBM Watson® Studio. IBM Watson® Studio is a product which is a suite of products for developing, training, and deploying AI models. In such a system, the user may want to use additional scoring metrics beyond those in the IBM Watson® Studio suite that might incorporate preferences of user or specific know-how of interactions in a model space in order to optimize the AI model 112 for the specific user's needs. In such an instance, the system and methods explained above enable the user to take advantage of the suite of products included on IBM Watson® Studio while also maintaining control over the AI algorithm 112. Additionally, this eliminates security concerns that may be involved with introducing non-native code into the IBM Watson® Studio platform.

FIG. 3 depicts a block diagram of components of first computing system 110 and second computing system 120, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

First computing system 110 and second computing system 120 include communications fabric 902, which provides communications between computer processor(s) 904, memory 906, persistent storage 908, communications unit 912, and input/output (I/O) interface(s) 914. Communications fabric 902 can be implemented with any architecture designed for passing data and/or control information between processors (such as microprocessors, communications and network processors, etc.), system memory, peripheral devices, and any other hardware components within a system. For example, communications fabric 902 can be implemented with one or more buses.

Memory 906 and persistent storage 908 are computer-readable storage media. In this embodiment, memory 906 includes random access memory (RAM) 916 and cache memory 918. In general, memory 906 can include any suitable volatile or non-volatile computer-readable storage media.

The AI model 112, scoring metric 114, test data 116 in first computing system 110; and scoring algorithm 122 in second computing system 120 are stored in persistent storage 908 for execution by one or more of the respective computer processors 904 via one or more memories of memory 906. In this embodiment, persistent storage 908 includes a magnetic hard disk drive. Alternatively, or in addition to a magnetic hard disk drive, persistent storage 908 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 908 may also be removable. For example, a removable hard drive may be used for persistent storage 908. Other examples include optical and magnetic disks, thumb drives, and smart cards that are inserted into a drive for transfer onto another computer-readable storage medium that is also part of persistent storage 908.

Communications unit 912, in these examples, provides for communications with other data processing systems or devices. In these examples, communications unit 912 includes one or more network interface cards. Communications unit 912 may provide communications through the use of either or both physical and wireless communications links. The AI model 112, scoring metric 114, test data 116 in first computing system 110; and scoring algorithm 122 in second computing system 120 may be downloaded to persistent storage 908 through communications unit 912.

I/O interface(s) 914 allows for input and output of data with other devices that may be connected to first computing system 110 and social media second computing system 120. For example, I/O interface 914 may provide a connection to external devices 920 such as a keyboard, keypad, a touch screen, and/or some other suitable input device. External devices 920 can also include portable computer-readable storage media such as, for example, thumb drives, portable optical or magnetic disks, and memory cards. Software and data used to practice embodiments of the present invention, e.g., the AI model 112, scoring metric 114, test data 116 in first computing system 110; and scoring algorithm 122 in second computing system 120, can be stored on such portable computer-readable storage media and can be loaded onto persistent storage 908 via I/O interface(s) 914. I/O interface(s) 914 can also connect to a display 922.

Display 922 provides a mechanism to display data to a user and may be, for example, a computer monitor.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and Scoring Metrics 96.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While steps of the disclosed method and components of the disclosed systems and environments have been sequentially or serially identified using numbers and letters, such numbering or lettering is not an indication that such steps must be performed in the order recited, and is merely provided to facilitate clear referencing of the method's steps. Furthermore, steps of the method may be performed in parallel to perform their described functionality.

What is claimed is:

1. A method for scoring AI models, the method comprising:
determining, by a first computing system, a result of an AI model based on input data;
sending, by the first computing system to a second computing system, the result of the AI model; and
receiving, by the first computing system from the second computing system, a scoring result of the AI model.

2. The method of claim 1 further comprising:
determining, by the first computing system, a scoring metric based on the result of the AI model; and
combining the scoring metric with the AI model.

3. The method of claim 1 wherein the input data comprises ground truth data.

4. The method of claim 1 wherein the input data comprises parameter test data.

5. The method of claim 4, wherein sending the result of the AI model further comprising sending the parameter test data.

6. The method of claim 1, wherein sending by the first computing system to the second computing system comprises a function call in an operating code of the first computing system specifying a url of the second computing system.

7. The method of claim 1, wherein the first computing system and the second computing system operate different operating systems.

8. A computer program product for scoring AI models, the computer program product comprising:
one or more computer readable storage media, and program instructions collectively stored on the one or more computer readable storage media, the program instructions comprising:
determining, by a first computing system, a result of an AI model based on input data;
sending, by the first computing system to a second computing system, the result of the AI model; and
receiving, by the first computing system from the second computing system, a scoring result of the AI model.

9. The computer program product of claim 8 further comprising:
determining, by the first computing system, a scoring metric based on the result of the AI model; and
combining the scoring metric with the AI model.

10. The computer program product of claim 8 wherein the input data comprises ground truth data.

11. The computer program product of claim 8 wherein the input data comprises parameter test data.

12. The computer program product of claim 11, wherein sending the result of the AI model further comprising sending the parameter test data.

13. The computer program product of claim 8, wherein sending by the first computing system to the second computing system comprises a function call in an operating code of the first computing system specifying a url of the second computing system.

14. The computer program product of claim 8, wherein the first computing system and the second computing system operate different operating systems.

15. A computer system for scoring AI models, the computer system comprising:
one or more processors, one or more computer-readable memories, one or more computer-readable storage devices, and program instructions stored on at least one of the one or more computer-readable storage devices for execution by at least one of the one or more processors via at least one of the one or more computer-readable memories, the program instructions comprising:
determining, by a first computing system, a result of an AI model based on input data;
sending, by the first computing system to a second computing system, the result of the AI model; and
receiving, by the first computing system from the second computing system, a scoring result of the AI model.

16. The computer system of claim 15 further comprising:
determining, by the first computing system, a scoring metric based on the result of the AI model; and
combining the scoring metric with the AI model.

17. The computer system of claim 15 wherein the input data comprises ground truth data.

18. The computer system of claim 15 wherein the input data comprises parameter test data.

19. The computer system of claim 18, wherein sending the result of the AI model further comprising sending the parameter test data.

20. The computer system of claim 15, wherein sending by the first computing system to the second computing system comprises a function call in an operating code of the first computing system specifying a url of the second computing system.
